(19) United States
(12) Patent Application Publication
(10) Pub. No.: US 2021/0203232 A1
(43) Pub. Date: Jul. 1, 2021

(54) POWER SUPPLY CONTROL DEVICE AND POWER SUPPLY DEVICE

(71) Applicant: NUVOTON TECHNOLOGY CORPORATION JAPAN, Kyoto (JP)

(72) Inventors: Tetsuya MIHASHI, Kyoto (JP); Takuya ISHII, Osaka (JP); Naoki KAWAMOTO, Hyogo (JP); Katsuyuki TABATA, Shiga (JP)

(21) Appl. No.: 17/203,405

(22) Filed: Mar. 16, 2021

Related U.S. Application Data
(63) Continuation of application No. PCT/JP2019/036002, filed on Sep. 13, 2019.

(30) Foreign Application Priority Data
Sep. 21, 2018 (JP) 2018-177706

(51) Int. Cl. H02M 3/158; H02J 7/34; B60L 53/20; B60L 15/20

(52) U.S. Cl. CPC H02M 3/1582; H02J 7/345; H02P 27/06; B60L 15/20; B60L 53/20

(57) ABSTRACT

A power supply control device that supplies a power supply voltage to a power supply terminal of a load (inverter), using a first power storage device and a second power storage device as power sources, includes: a power converter; a switch disposed between one terminal of the first power storage device and the power supply terminal of the load (inverter); and a control circuit that controls a conduction state of the switch.

### CROSS REFERENCE TO RELATED APPLICATIONS

This is a continuation application of PCT International Application No. PCT/JP2019/036002 filed on Sep. 13, 2019, designating the United States of America, which is based on and claims priority of Japanese Patent Application No. 2018-177706 filed on Sep. 21, 2018. The entire disclosures of the above-identified applications, including the specifications, drawings and claims are incorporated herein by reference in their entirety.

### FIELD

The present disclosure relates to a power supply control device and a power supply device.

### BACKGROUND

Electric vehicles and hybrid vehicles, which have recently received attention as environment-friendly automobiles, include a first power storage device, an inverter, and a motor driven by the inverter, and the first power storage device is typically a secondary battery such as a lithium-ion battery.

Patent Literature 1 discloses a power supply control device that supplies a power supply voltage to a power supply terminal of an inverter being a load, using a first power storage device as a power source.

### CITATION LIST

### Patent Literature

PTL 1: Japanese Unexamined Patent Application Publication No. 2010-273454

### SUMMARY

### Technical Problem

The conventional power supply control device disclosed in Patent Literature 1 includes a power converter disposed in a current path between the first power storage device and the load. The conventional power supply control device therefore suffers from a power loss caused by this power converter in power transfer between the first power storage device and the load. In general, it is desirable to reduce the power loss in the power transfer between the first power storage device and the load.

Hence, the present disclosure provides a power supply control device and a power supply device capable of reducing a power loss in power transfer between the first power storage device and the load.

### Solutions to Problem

A power supply control device according to an aspect of the present disclosure is a power supply control device that supplies a power supply voltage to a power supply terminal of a load, using a first power storage device and a second power storage device as power sources, and includes: a power converter; a switch disposed between one terminal of the first power storage device and the power supply terminal of the load; and a control circuit that controls a conduction state of the switch.

Furthermore, the power converter may be disposed between one terminal of the second power storage device and the power supply terminal of the load.

Furthermore, the control circuit may place the switch in a conducting state when a potential difference between the one terminal of the first power storage device and the power supply terminal of the load is smaller than a predetermined amount.

Furthermore, the power converter may be a buck-boost converter capable of bi-directional power transfer.

Furthermore, the buck-boost converter may include: a first series circuit in which a first high-side switch and a first low-side switch are connected in series, and which is disposed in parallel with the second power storage device; a second series circuit in which a second high-side switch and a second low-side switch are connected in series, and which is disposed in parallel with the load; and an inductor disposed between (i) a connection point of the first high-side switch and the first low-side switch and (ii) a connection point of the second high-side switch and the second low-side switch.

Furthermore, the power converter may be a converter that bucks voltage from the one terminal of the second power storage device to the power supply terminal of the load, and boosts voltage from the power supply terminal of the load to the one terminal of the second power storage device.

Furthermore, the converter may include: a series circuit in which a high-side switch and a low-side switch are connected in series, and which is disposed in parallel with the second power storage device; and an inductor disposed between (i) a connection point of the high-side switch and the low-side switch and (ii) the power supply terminal of the load.

Furthermore, the power converter may be a converter that boosts voltage from the one terminal of the second power storage device to the power supply terminal of the load, and bucks voltage from the power supply terminal of the load to the one terminal of the second power storage device.

Furthermore, the converter may include: a series circuit in which a high-side switch and a low-side switch are connected in series, and which is disposed in parallel with the load; and an inductor disposed between (i) a connection point of the high-side switch and the low-side switch and (ii) the one terminal of the second power storage device.

Furthermore, the power converter may be a converter that boosts voltage from an other terminal of the second power storage device to the power supply terminal of the load, and bucks voltage from the power supply terminal of the load to the other terminal of the second power storage device.

Furthermore, the converter may include: a series circuit in which a high-side switch and a low-side switch are connected in series, and which is disposed in parallel with the load; and an inductor disposed between (i) a connection point of the high-side switch and the low-side switch and (ii) the other terminal of the second power storage device.

Furthermore, the first power storage device may have a voltage of at least 30 V.

A power supply device according to an aspect of the present disclosure is a power supply device which includes a first power storage device and a second power storage device, and supplies power supply voltage to a power supply terminal of a load, using the first power storage device and the second power storage device as power sources, wherein the power supply device further includes: a power converter; a switch disposed between one terminal of the first power storage device and the power supply terminal of the load; and a control circuit that controls a conduction state of the switch.

Furthermore, the power converter may be disposed between one terminal of the second power storage device and the power supply terminal of the load.

Furthermore, the power converter may be a converter that boosts voltage from an other terminal of the second power storage device to the power supply terminal of the load, and bucks voltage from the power supply terminal of the load to the other terminal of the second power storage device.

### Advantageous Effects

A power supply control device and a power supply device according to an aspect of the present disclosure are capable of reducing a power loss in power transfer between a first power storage device and a load.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram of an example of a circuit configuration of a power supply device according to Embodiment 1.

FIG. 2A is a schematic diagram of how power supply voltage is supplied to a load according to Embodiment 1.

FIG. 2B is a schematic diagram of how regenerated power is stored in a second power storage device according to Embodiment 1.

FIG. 3 is a block diagram of a circuit configuration of a power supply device according to a comparative example.

FIG. 4 is a block diagram of an example of a circuit configuration of a switch and a control circuit according to Embodiment 1.

FIG. 5 is a block diagram of an example of a circuit configuration of the power supply device according to Embodiment 1.

FIG. 6 is a timing chart illustrating how a vehicle speed of a vehicle, potentials of parts, and a conduction state of a switch according to Embodiment 1 change with time.

FIG. 7 is a block diagram of an example of a circuit configuration of a power supply device according to Embodiment 2.

FIG. 8 is a timing chart illustrating how a vehicle speed of a vehicle, potentials of parts, and a conduction state of a switch according to Embodiment 2 change with time.

FIG. 9 is a block diagram of an example of a circuit configuration of a power supply device according to Embodiment 3.

FIG. 10 is a timing chart illustrating how a vehicle speed of a vehicle, potentials of parts, and a conduction state of a switch according to Embodiment 3 change with time.

FIG. 11 is a block diagram of an example of a circuit configuration of a power supply device according to Embodiment 4.

FIG. 12 is a timing chart illustrating how a vehicle speed of a vehicle, potentials of parts, and a conduction state of a switch according to Embodiment 4 change with time.

### DESCRIPTION OF EMBODIMENTS

Hereinafter, specific examples of a power supply control device and a power supply device according to an aspect of the present disclosure will be described with reference to the Drawings. Each of the following embodiments shows a specific example of the present disclosure. Therefore, numerical values, shapes, structural components, the arrangement and connection of the structural components, etc., shown in the following embodiments are mere examples, and thus are not intended to limit the present disclosure. Furthermore, the respective figures are schematic diagrams, and are not necessarily precise illustrations.

### Embodiment 1

A power supply device according to Embodiment 1 will be described below. This power supply device is a device that supplies a power supply voltage to a power supply terminal of a load. The description will be given here of an example in which the load is assumed to be an inverter that drives a motor serving as a motive power source of an electric vehicle, a hybrid vehicle, or the like. However, the load is not necessarily limited to an inverter that drives a motor.

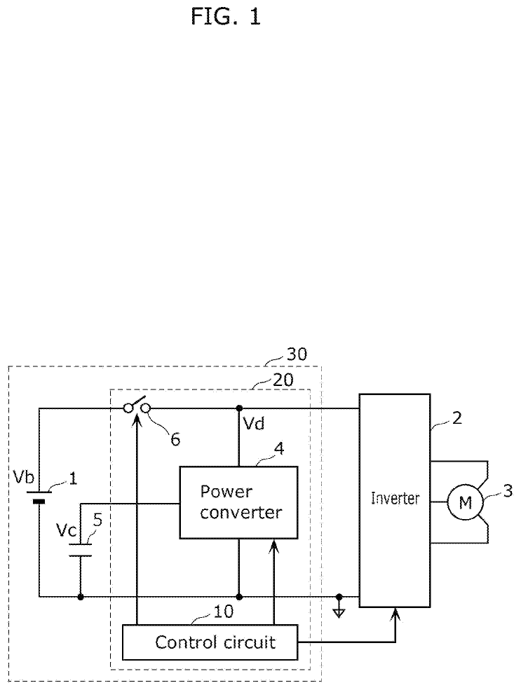

FIG. 1 is a block diagram of an example of a circuit configuration of power supply device 30 according to Embodiment 1.

As illustrated in FIG. 1, power supply device 30 includes first power storage device 1, second power storage device 5, and power supply control device 20, and supplies a power supply voltage to a power supply terminal of inverter 2 being the load. A ground of power supply device 30 and a ground of inverter 2 are the same.

Inverter 2 includes a power supply terminal and a ground terminal and drives motor 3 using the power supply voltage supplied to the power supply terminal from power supply device 30. The ground terminal is connected to the ground. Hereinafter, a potential of the power supply terminal of inverter 2 will be denoted as Vd.

Motor 3 is a motive power source of an electric vehicle or a hybrid vehicle and, for example, accelerates, cruises, and decelerates the electric vehicle or the hybrid vehicle. When decelerating the electric vehicle or the hybrid vehicle, motor 3 operates as a power generator to generate regenerated power. The power regenerated by motor 3 is supplied via the power supply terminal of inverter 2 to power supply device 30.

First power storage device 1 includes one terminal and the other terminal and stores power between the one terminal and the other terminal. First power storage device 1 is, for example, a secondary battery. The other terminal of first power storage device 1 is connected to the ground. Hereinafter, a potential of the one terminal of first power storage device 1 will be denoted as Vb. In a case where a hybrid vehicle including motor 3 as a motive power source is a mild hybrid, Vb is 48 V, for example.

Second power storage device 5 includes one terminal and the other terminal and stores power between the one terminal and the other terminal. Second power storage device 5 is, for example, a capacitor, a secondary battery, or the like. The other terminal of second power storage device 5 is connected to the ground. Hereinafter, a potential of the one terminal of second power storage device 5 will be denoted as Vc.

Power supply control device 20 uses first power storage device 1 and second power storage device 5 as power sources to supply the power supply voltage to the power supply terminal of inverter 2 being the load. A ground of power supply control device 20 and a ground of power supply device 30 are the same.

Power supply control device 20 includes switch 6, power converter 4, and control circuit 10.

Switch 6 is disposed between the one terminal of first power storage device 1 and the power supply terminal of inverter 2 being the load and switches a conduction state between the one terminal of first power storage device 1 and the power supply terminal of inverter 2 being the load to one of a conducting state and an interrupted state.

Power converter 4 is disposed between the one terminal of second power storage device 5 and the power supply terminal of inverter 2 being the load and transfers power from the one terminal of second power storage device 5 to the power supply terminal of inverter 2 or from the power supply terminal of inverter 2 to the one terminal of second power storage device 5, irrespective of whichever has a higher potential. Specifically, power converter 4 is a converter capable of bi-directional power transfer to the one terminal of second power storage device 5 and the power supply terminal of inverter 2 being the load (buck-boost converter).

Control circuit 10 controls the conduction state of switch 6. Specifically, control circuit 10 places switch 6 in the conducting state when a potential difference between the one terminal of first power storage device 1 and the power supply terminal of inverter 2, which is the load, is smaller than a predetermined amount, and places switch 6 in the interrupted state when the potential difference is larger than the predetermined amount. Control circuit 10 also controls operation of power converter 4 and operation of inverter 2.

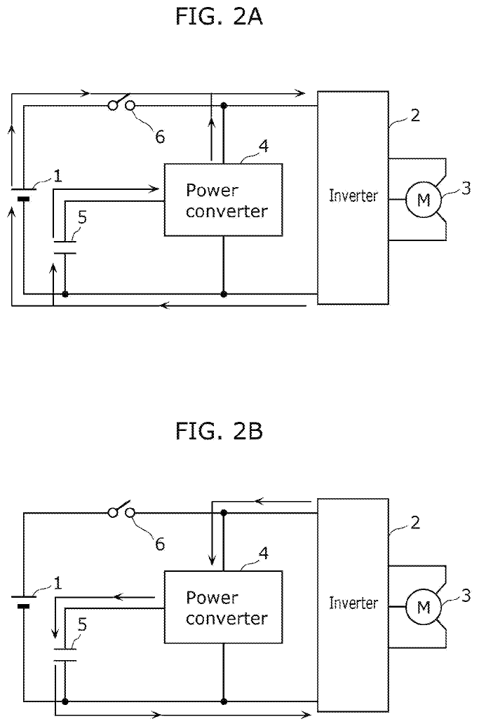

FIG. 2A is a schematic diagram of how power supply control device 20 uses first power storage device 1 and second power storage device 5 as power sources to supply the power supply voltage to the power supply terminal of inverter 2 being the load when the conduction state of switch 6 is the conducting state, that is, when the potential difference between Vb and Vd is smaller than the predetermined amount.

As illustrated in FIG. 2A, when the potential difference between Vb and Vd is smaller than the predetermined amount, power is supplied to inverter 2 from both first power storage device 1 and second power storage device 5. That is, when the potential difference between Vb and Vd is smaller than the predetermined amount, power supply from first power storage device 1 to inverter 2 is assisted by power supply from second power storage device 5 to inverter 2. This prevents fast discharge of first power storage device 1, preventing or reducing deterioration of first power storage device 1.

Since there is no circuit other than switch 6 in a current path between first power storage device 1 and inverter 2 as illustrated in FIG. 2A, a power loss in the power transfer between first power storage device 1 and inverter 2 is limited to a power loss caused by switch 6.

In contrast, when the potential difference between Vb and Vd is larger than the predetermined amount, the conduction state of switch 6 is the interrupted state. In the power supply from first power storage device 1 to inverter 2, this prevents fast discharge of first power storage device 1 caused by a relatively large potential difference between Vb and Vd. As a result, deterioration of first power storage device 1 is prevented or reduced.

FIG. 2B is a schematic diagram of how the power regenerated by motor 3 is stored in second power storage device 5 when the conduction state of switch 6 is the interrupted state, that is, when the potential difference between Vb and Vd is larger than the predetermined amount.

When Vd>Vc, power converter 4 performs a buck operation such that Vd is bucked to Vc. When Vd<Vc, power converter 4 performs a boost operation such that Vd is boosted to Vc. The power regenerated by motor 3 is thus transferred to second power storage device 5 irrespective of whichever of Vd and Vc is a higher potential. That is, the power regenerated by motor 3 is stored in second power storage device 5 irrespective of whichever of Vd and Vc is a higher potential. In other words, the power regenerated by motor 3 is stored in second power storage device 5 even when Vd is in a range lower than Vc.

When the potential difference between Vb and Vd is larger than the predetermined amount, the conduction state of switch 6 is the interrupted state. The power regenerated by motor 3 is thus not stored in first power storage device 1. In storing the power regenerated by motor 3 in first power storage device 1, this prevents fast charge of first power storage device 1 caused by a relatively large potential difference between Vb and Vd. As a result, deterioration of first power storage device 1 is prevented or reduced.

In contrast, when the potential difference between Vb and Vd is smaller than the predetermined amount, the conduction state of switch 6 is the conducting state. The power regenerated by motor 3 is thus stored also in first power storage device 1. At this time, the potential difference between Vb and Vd being smaller than the predetermined amount prevents fast charge of first power storage device 1 caused by a relatively large potential difference between Vb and Vd. As a result, deterioration of first power storage device 1 is prevented or reduced.

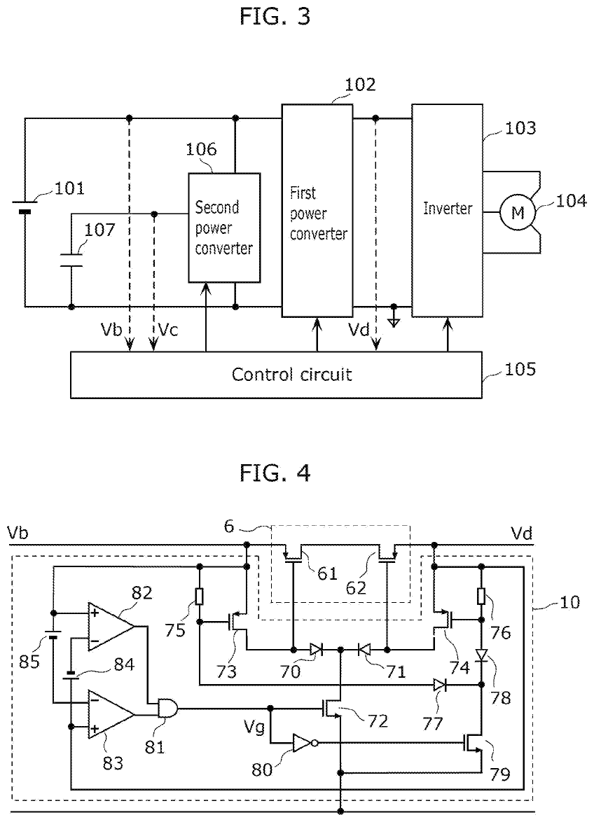

FIG. 3 is a block diagram of a circuit configuration of a power supply device according to a comparative example.

As illustrated in FIG. 3, the power supply device according to the comparative example includes first power storage device 101, second power storage device 107, first power converter 102, second power converter 106, and control circuit 105, and supplies a power supply voltage to a power supply terminal of inverter 103 being a load. A ground of the power supply device according to the comparative example and a ground of inverter 103 are the same. Out of constituent components of the power supply device according to the comparative example, first power converter 102, second power converter 106, and control circuit 105 form a power supply control device according to the comparative example.

First power storage device 101, second power storage device 107, inverter 103, and motor 104 are the same as first power storage device 1, second power storage device 5, inverter 2, and motor 3, respectively.

First power converter 102 has a boost mode in which a potential Vb of one terminal of first power storage device 101 is boosted and output to a power supply terminal of inverter 103, and a buck mode in which a potential Vd of the power supply terminal of inverter 103 is bucked and output to one terminal of first power storage device 101.

Second power converter 106 has a boost mode in which a potential Vc of one terminal of second power storage device 107 is boosted and output to the one terminal of first power storage device 101 and a buck mode in which the potential Vb of the one terminal of first power storage device 101 is bucked and output to the one terminal of the second power storage device.

Control circuit 105 controls operation of first power converter 102, operation of second power converter 106, and operation of inverter 103.

Control circuit 105 causes both first power converter 102 and second power converter 106 to operate in their boost modes when, for example, inverter 103 consumes a relatively high power, that is, when an electric vehicle or a hybrid vehicle starts/accelerates. This causes both first power storage device 101 and second power storage device 107 to serve as power sources to supply a power supply voltage to the power supply terminal of inverter 103. At this time, control circuit 105 controls the operation of first power converter 102 and the operation of second power converter 106 so as to avoid fast discharge of first power storage device 101.

Control circuit 105 causes first power converter 102 to operate in its boost mode and stops the operation of second power converter 106 when, for example, inverter 103 consumes a relatively low power, that is, when the electric vehicle or the hybrid vehicle cruises, traveling at a substantially constant speed. This causes first power storage device 101 to serve as a power source to supply a power supply voltage to the power supply terminal of inverter 103.

Control circuit 105 causes both first power converter 102 and second power converter 106 to operate in their buck modes when, for example, power regenerated by motor 104 is supplied from the power supply terminal of inverter 103, that is, when the electric vehicle or the hybrid vehicle decelerates. This causes the power regenerated by motor 104 to be stored in both first power storage device 101 and second power storage device 107. At this time, control circuit 105 controls the operation of first power converter 102 and the operation of second power converter 106 so as to avoid fast charge of first power storage device 101.

In the power supply control device according to the comparative example having the above-described configuration, first power converter 102 intervenes in power transfer between first power storage device 101 and inverter 103. Therefore, in the power transfer between first power storage device 101 and inverter 103, a power loss occurs with power conversion by first power converter 102. In contrast, power supply control device 20 includes no circuit other than switch 6 in the current path between first power storage device 1 and inverter 2, as described above. As a result, in the power transfer between first power storage device 1 and inverter 2, a power loss is limited to a power loss caused by switch 6.

In this manner, power supply control device 20 can reduce the power loss in the power transfer between first power storage device 101 and inverter 103 being the load more than the power supply control device according to the comparative example.

In the power supply control device according to the comparative example having the above-described configuration, when the power regenerated by motor 104 is transferred from inverter 103 via first power converter 102 to second power converter 106, an output voltage to second power converter 106 is clamped to the potential Vb of the one terminal of first power storage device 101. The power regenerated by motor 104 is thus not stored in second power storage device 107 when Vd is in a range lower than Vb. In contrast, in power supply control device 20, when the power regenerated by motor 3 is transferred via inverter 2 to power converter 4, an output voltage to power converter 4 is not clamped to an output voltage Vb of first power storage device 1. As a result, in power supply control device 20, the power regenerated by motor 3 is stored in second power storage device 5 even when Vd is in the range lower than Vb.

In this manner, power supply control device 20 can store the power regenerated by motor 3 in second power storage device 5 more effectively than the power supply control device according to the comparative example.

FIG. 4 is a block diagram of an example of a circuit configuration of switch 6 and control circuit 10. Note that FIG. 4 is a diagram simply illustrating a configuration of a circuit that implements a function of control circuit 10 for controlling the conduction state of switch 6. Control circuit 10 actually includes circuits in addition to the circuit configuration illustrated in FIG. 4.

As illustrated in FIG. 4, switch 6 includes PMOSFET 61 and PMOSFET 62.

To a source terminal of PMOSFET 61, the potential Vb of the one terminal of first power storage device 101 is applied, and to a source terminal of PMOSFET 62, the potential Vd of the power supply terminal of inverter 2 is applied. A drain terminal of PMOSFET 61 is connected to a drain terminal of PMOSFET 62. A bi-directional switch including PMOSFET 61 and PMOSFET 62 is thus formed. That is, switch 6 is the bi-directional switch including PMOSFET 61 and PMOSFET 62.

As illustrated in FIG. 4, control circuit 10 includes diode 70, diode 71, NMOSFET 72, PMOSFET 73, PMOSFET 74, resistor 75, resistor 76, diode 77, diode 78, NMOSFET 79, inverter 80, AND gate 81, comparator 82, comparator 83, voltage source 84, and voltage source 85.

A gate terminal of PMOSFET 61 and a gate terminal of PMOSFET 62 are connected to a drain terminal of NMOSFET 72 via diode 70 and diode 71, respectively. NMOSFET 72 being turned on causes the gate terminals of PMOSFET 61 and PMOSFET 62 to be at a low potential, placing PMOSFET 61 and PMOSFET 62 in an ON state. In addition, between the source terminals and the gate terminals of PMOSFET 61 and PMOSFET 62, PMOSFET 73 and PMOSFET 74 are connected, respectively. Thus, when PMOSFET 73 is on, PMOSFET 61 is off, and when PMOSFET 74 is on, PMOSFET 62 is off.

In addition, between source terminals and gate terminals of PMOSFET 73 and PMOSFET 74, resistor 75 and resistor 76 are connected, respectively, and the gate terminals of PMOSFET 73 and PMOSFET 74 are connected to a drain terminal of NMOSFET 79 via diode 77 and diode 78, respectively. NMOSFET 79 being turned on causes the gate terminals of PMOSFET 73 and PMOSFET 74 to be at a low potential, placing PMOSFET 73 and PMOSFET 74 in the ON state.

Accordingly, as NMOSFET 79 is turned on, PMOSFET 61 and PMOSFET 62 are placed in an OFF state.

In contrast, NMOSFET 79 being off causes the gate terminals of PMOSFET 73 and PMOSFET 74 to be at a high potential by resistor 75 and resistor 76, respectively, placing PMOSFET 73 and PMOSFET 74 in the OFF state.

To a gate terminal of NMOSFET 79, drive signal Vg applied to a gate terminal of NMOSFET 72 is applied after being logically inverted by inverter 80. Therefore, when drive signal Vg applied to the gate terminal of NMOSFET 72 has a logical value of “H”, switch 6 is on, and when drive signal Vg has a logical value of “L”, switch 6 is off.

Drive signal Vg is an output of AND gate 81, and AND gate 81 receives outputs of comparator 82 and comparator 83. Comparator 82 receives the potential Vb with its positive input terminal and receives a potential obtained by subtraction of a potential of voltage source 84 from the potential Vd with its negative input terminal. Comparator 83 receives the potential Vd with its positive input terminal and receives a potential obtained by subtraction of a potential of voltage source 85 from the potential Vb with its negative input terminal. When voltage source 84 and voltage source 85 are at the same potential, which is denoted by ΔV, comparator 82 outputs the logical value of “H” when Vb>Vd−ΔV, and comparator 83 outputs the logical value of “H” when Vd>Vb−ΔV.

Therefore, when −ΔV<Vd−Vb<ΔV, that is, when the potential difference between Vb and Vd is smaller than predetermined amount ΔV, drive signal Vg has the logical value of “H”, placing the conduction state of switch 6 in the conducting state. Here, predetermined amount ΔV is sufficiently small relative to Vb and Vd. Accordingly, when Vb≈Vd, the conduction state of switch 6 is the conducting state. When switch 6 the conduction state of which is the conducting state has a resistance value Ron, an absolute value of a charge-discharge current of first power storage device 1 is limited to ΔV/Ron. As a result, a relation Vb≈Vd is maintained in the power supply from first power storage device 1 to inverter 2 and in power regeneration from inverter 2 to first power storage device 1, which can prevent a relatively large charge-discharge current from flowing into first power storage device 1.

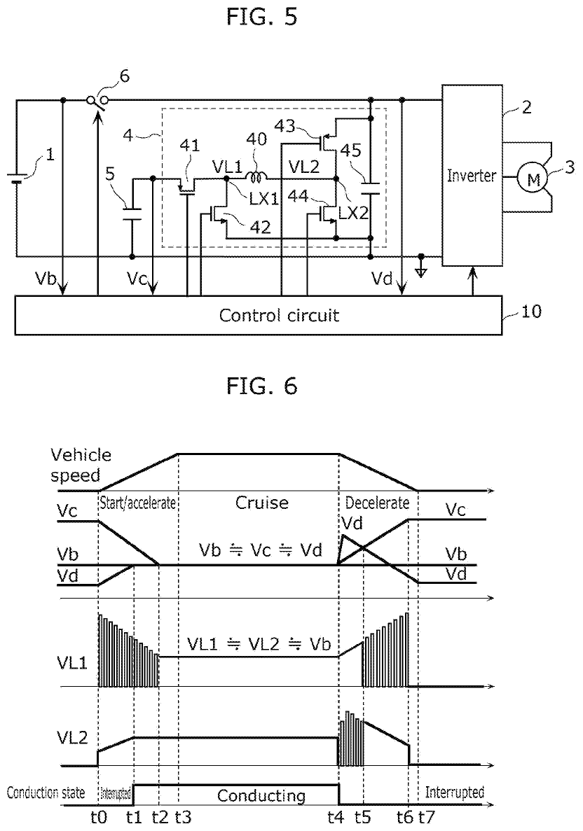

FIG. 5 is a block diagram of an example of the circuit configuration of power supply device 30. FIG. 5 is a diagram of a configuration of power converter 4 more in detail than FIG. 1.

Power converter 4 is an H-bridge converter (buck-boost converter) capable of bi-directional power transfer.

As illustrated in FIG. 5, power converter 4 includes first high-side switch 41, first low-side switch 42, second high-side switch 43, second low-side switch 44, inductor 40, and smoothing capacitor 45.

First high-side switch 41 and second high-side switch 43 are both PMOSFETs, and first low-side switch 42 and second low-side switch 44 are both NMOSFETs.

First high-side switch 41 and first low-side switch 42 are connected in series, forming a first series circuit. The first series circuit is disposed in parallel with second power storage device 5. By alternately turning on/off first high-side switch 41 and first low-side switch 42, a potential of connection point LX1 between first high-side switch 41 and first low-side switch 42 alternates between the potential Vc of second power storage device 5 and a zero potential. Hereinafter, the potential of connection point LX1 will be denoted as VL1.

Second high-side switch 43 and second low-side switch 44 are connected in series, forming a second series circuit. The second series circuit is disposed in parallel with smoothing capacitor 45. Smoothing capacitor 45 is disposed in parallel with inverter 2. By alternately turning on/off second high-side switch 43 and second low-side switch 44, a potential of connection point LX2 between second high-side switch 43 and second low-side switch 44 alternates between the potential Vd of the power supply terminal of inverter 2 and the zero potential. Hereinafter, the potential of connection point LX2 will be denoted as VL2.

Inductor 40 includes one terminal connected to connection point LX1 and the other terminal connected to connection point LX2.

Control circuit 10 receives Vb, Vc, and Vd, and outputs a control signal for switch 6, a control signal for power converter 4, and a control signal for inverter 2.

An operation example of power converter 4 will be described below.

First, when Vc>Vd, second high-side switch 43 is fixed to the ON state, second low-side switch 44 is fixed to the OFF state, and first high-side switch 41 and first low-side switch 42 are switched alternately.

In a case where power is supplied from second power storage device 5 to inverter 2 when Vc>Vd, when first high-side switch 41 is on, current flows in a loop: second power storage device 5→first high-side switch 41→inductor 40→second high-side switch 43→smoothing capacitor 45 (or inverter 2)→second power storage device 5, and when first high-side switch 41 is off, current flows in a loop: first low-side switch 42→inductor 40→second high-side switch 43→smoothing capacitor 45 (or inverter 2)→first low-side switch 42.

That is, power converter 4 operates as a converter (buck converter) that supplies power from second power storage device 5 to inverter 2.

In a case where power is regenerated from inverter 2 to second power storage device 5 when Vc>Vd, when first low-side switch 42 is on, current flows in a loop: smoothing capacitor 45 (or inverter 2)→second high-side switch 43→inductor 40→first low-side switch 42→smoothing capacitor 45 (or inverter 2), and when first low-side switch 42 is off, current flows in a loop: smoothing capacitor 45 (or inverter 2)→second high-side switch 43→inductor 40→first high-side switch 41→second power storage device 5→smoothing capacitor 45 (or inverter 2).

That is, power converter 4 operates as a converter (boost converter) that regenerates power from inverter 2 to second power storage device 5.

Next, when Vc<Vd, first high-side switch 41 is fixed to the ON state, first low-side switch 42 is fixed to the OFF state, and second high-side switch 43 and second low-side switch 44 are switched alternately.

In a case where power is supplied from second power storage device 5 to inverter 2 when Vc<Vd, when second low-side switch 44 is on, current flows in a loop: second power storage device 5→first high-side switch 41→inductor 40→second low-side switch 44→second power storage device 5, and when second low-side switch 44 is off, current flows in a loop: second power storage device 5→first high-side switch 41→inductor 40→second high-side switch 43→smoothing capacitor 45 (or inverter 2)→second power storage device 5.

That is, power converter 4 operates as a converter (boost converter) that supplies power from second power storage device 5 to inverter 2.

In a case where power is regenerated from inverter 2 to second power storage device 5 when Vc<Vd, when second high-side switch 43 is on, current flows in a loop: smoothing capacitor 45 (or inverter 2)→second high-side switch 43→inductor 40→first high-side switch 41→second power storage device 5→smoothing capacitor 45 (or inverter 2), and when second high-side switch 43 is off, current flows in a loop: second low-side switch 44→inductor 40→first high-side switch 41→second power storage device 5→second low-side switch 44.

That is, power converter 4 operates as a converter (buck converter) that regenerates power from inverter 2 to second power storage device 5.

Next, when Vc≈Vd, first high-side switch 41 and second high-side switch 43 are fixed to the ON state, and first low-side switch 42 and second low-side switch 44 are fixed to the OFF state.

FIG. 6 is a timing chart illustrating how a vehicle speed of an electric vehicle or a hybrid vehicle (hereinafter, referred to as “vehicle”), Vb, Vd, Vc, VL1, and VL2, and the conduction state of switch 6 change with time. Here, description will be given on the assumption that a capacity of first power storage device 1 is sufficiently large, and variations in Vb with charging and discharging first power storage device 1 are negligibly small.

Before time point t0, the vehicle is in a stop state. At this time, power converter 4 and inverter 2 are stopped, and the conduction state of switch 6 is the interrupted state. It is assumed here that, before time point t0, first power storage device 1 and second power storage device 5 are charged sufficiently, and Vc>Vb>Vd holds.

During a period between time points t0 to t3, the vehicle starts/accelerates. When time point t0 comes, control circuit 10 causes inverter 2 to operate. This causes motor 3 to rotate, increasing the vehicle speed. Additionally, control circuit 10 controls power converter 4 to cause power converter 4 to operate as a converter (buck converter) that supplies power from second power storage device 5 to inverter 2. This makes VL1 form a switching waveform a high potential of which is Vc, and VL2 is Vd. When the power supply from second power storage device 5 to inverter 2 is started, Vd rises. This increases a rotational speed of motor 3, further increasing the vehicle speed. The above corresponds to a period up to time point t1, at which Vd reaches Vb, and potentials of parts satisfy a relation of Vc>Vb>Vd.

When time point t1 comes, the conduction state of switch 6 is changed from the interrupted state to the conducting state, and power is supplied to inverter 2 also from first power storage device 1. The above corresponds to a period up to time point t2, at which Vc reaches Vd, and the potentials of the parts satisfy a relation of Vc>Vb≈Vd.

When time point t2 comes, Vc≈Vd holds, and thus power converter 4 stops the switching of first high-side switch 41 and first low-side switch 42, and fixes first high-side switch 41 and second high-side switch 43 to the ON state, so that power to inverter 2 is supplied from first power storage device 1. The above corresponds to a period up to time point t3, at which the vehicle starts cruising, and the potentials of the parts satisfy a relation of Vc≈Vb≈Vd.

When time point t3 comes, power supply device 30 performs the same operation as in the period from time point t2 to time point t3. As a result, the power to inverter 2 is supplied from first power storage device 1. The above corresponds to a period up to time point t4, at which the vehicle starts decelerating, and the potentials of the parts satisfy a relation of Vc≈Vb≈Vd.

When time point t4 comes, motor 3 regenerates power, and Vd rises. As a result, the conduction state of switch 6 is changed from the conducting state to the interrupted state. This prevents excessive regenerative current from flowing to first power storage device 1, preventing fast charge of first power storage device 1. Additionally, control circuit 10 controls power converter 4 to cause power converter 4 to operate as a converter (buck converter) that transfers the regenerated power from inverter 2 to second power storage device 5. The power regenerated by motor 3 is thus stored in second power storage device 5. The above corresponds to a period up to time point t5, at which Vd reaches Vc, and the potentials of the parts satisfy a relation of Vd>Vc>Vb.

When time point t5 is passed, and Vd falls below Vc, control circuit 10 controls power converter 4 to cause power converter 4 to operate as a converter (boost converter) that transfers the regenerated power from inverter 2 to second power storage device 5. The power regenerated by motor 3 is thus stored in second power storage device 5. The above corresponds to a period up to time point t6, at which Vd reaches a predetermined threshold value, and the potentials of the parts satisfy a relation of Vc>Vd>Vb, a relation of Vc>Vb≈Vd, and a relation of Vc>Vb>Vd in this order with time. Note that, when Vb≈Vd, the conduction state of switch is temporarily a conducting state, which is however not illustrated in FIG. 6. During a period in which the conduction state of switch 6 is temporarily the conducting state, the power regenerated by motor 3 is also stored in first power storage device 1.

When time point t6 comes, and Vd reaches the predetermined threshold value, control circuit 10 stops power converter 4. This ends the storage of the power regenerated by motor 3 in second power storage device 5. At the same time, the vehicle further decelerates by a mechanical brake and then stops at time point t7.

As described above, in power supply device 30, the power regenerated by motor 3 is stored in second power storage device 5 even when Vd is in the range lower than Vc, by causing power converter 4 to operate as a converter (buck-boost converter) capable of bi-directional power transfer, more specifically, by making power converter 4 have a configuration including the first series circuit in which first high-side switch 41 and first low-side switch 42 are connected in series and that is disposed in parallel with second power storage device 5, the second series circuit in which second high-side switch 43 and second low-side switch 44 are connected in series and that is disposed in parallel with inverter 2 being the load, and inductor 40 that is disposed between connection point LX1 between first high-side switch 41 and first low-side switch 42, and connection point LX2 between second high-side switch 43 and second low-side switch 44.

### Embodiment 2

A power supply device according to Embodiment 2, which is configured such that power supply device 30 according to Embodiment 1 is partly altered, will be described below.

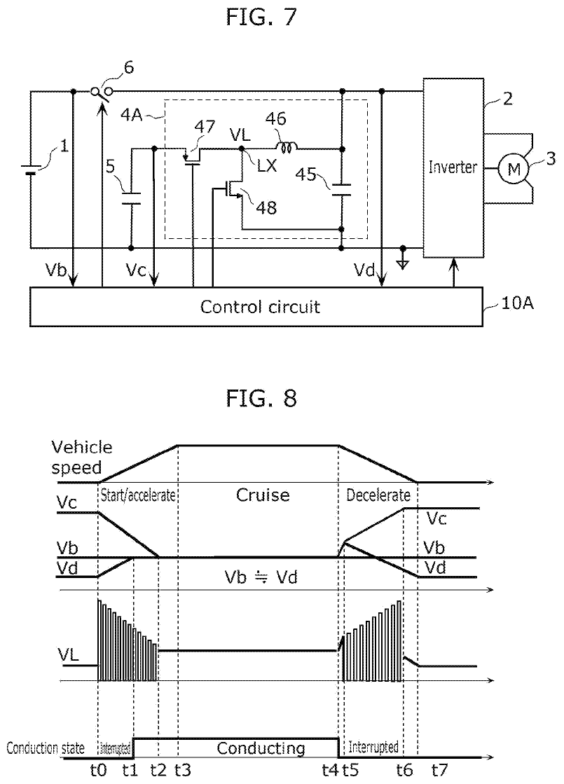

FIG. 7 is a block diagram of an example of a circuit configuration of a power supply device according to Embodiment 2. In the following description, constituent components of the power supply device according to Embodiment 2 that are the same as those of power supply device 30 according to Embodiment 1 will be denoted by the same reference characters and will not be described in detail because the constituent components have already been described. Differences from power supply device 30 will be mainly described.

As illustrated in FIG. 7, the power supply device according to Embodiment 2 is configured such that, from power supply device 30 according to Embodiment 1, power converter 4 is changed to power converter 4A, and control circuit 10 is changed to control circuit 10A. In the power supply device according to Embodiment 2, Vc is maintained at not less than Vd all the time.

Control circuit 10A controls a conduction state of switch 6 as with control circuit 10 according to Embodiment 1. Control circuit 10A also controls operation of power converter 4A and operation of inverter 2. More specifically, control circuit 10A receives Vb, Vc, and Vd, and outputs a control signal for switch 6, a control signal for power converter 4A, and a control signal for inverter 2.

Power converter 4A is a converter that bucks voltage from one terminal of second power storage device 5 to a power supply terminal of inverter 2 being a load and boosts voltage from the power supply terminal of inverter 2 being the load to the one terminal of second power storage device 5.

As illustrated in FIG. 7, power converter 4A includes high-side switch 47, low-side switch 48, inductor 46, and smoothing capacitor 45.

High-side switch 47 is a PMOSFET, and low-side switch 48 is an NMOSFET.

High-side switch 47 and low-side switch 48 are connected in series, forming a series circuit. The series circuit is disposed in parallel with second power storage device 5. By alternately turning on/off high-side switch 47 and low-side switch 48, a potential of connection point LX between high-side switch 47 and low-side switch 48 alternates between a potential Vc of second power storage device 5 and a zero potential. Hereinafter, the potential of connection point LX will be denoted as VL.

Inductor 40 includes one terminal connected to connection point LX and the other terminal connected to the power supply terminal of inverter 2.

FIG. 8 is a timing chart illustrating how a vehicle speed of a vehicle, Vb, Vd, Vc, and VL, and the conduction state of switch 6 change with time. Here, description will be given on the assumption that a capacity of first power storage device 1 is sufficiently large, and variations in Vb with charging and discharging first power storage device 1 are negligibly small.

Before time point t0, the vehicle is in a stop state. At this time, power converter 4A and inverter 2 are stopped, and the conduction state of switch 6 is an interrupted state. It is assumed here that, before time point t0, first power storage device 1 and second power storage device 5 are charged sufficiently, and Vc>Vb>Vd holds.

During a period between time points t0 to t3, the vehicle starts/accelerates. When time point t0 comes, control circuit 10A causes inverter 2 to operate. This causes motor 3 to rotate, increasing the vehicle speed. Additionally, control circuit 10A controls power converter 4A to cause power converter 4A to operate as a converter (buck converter) that supplies power from second power storage device 5 to inverter 2. This makes VL form a switching waveform a high potential of which is Vc. When the power supply from second power storage device 5 to inverter 2 is started, Vd rises. This increases a rotational speed of motor 3, further increasing the vehicle speed. The above corresponds to a period up to time point t1, at which Vd reaches Vb, and potentials of parts satisfy a relation of Vc>Vb>Vd.

When time point t1 comes, the conduction state of switch 6 is changed from the interrupted state to the conducting state, and power is supplied to inverter 2 also from first power storage device 1. The above corresponds to a period up to time point t2, at which Vc reaches Vd, and the potentials of the parts satisfy a relation of Vc>Vb≈Vd.

When time point t2 comes, Vc≈Vd holds, and thus power converter 4A stops the switching of high-side switch 47 and low-side switch 48, and fixes high-side switch 47 and low-side switch 48 to the ON state, so that power to inverter 2 is supplied from first power storage device 1. The above corresponds to a period up to time point t3, at which the vehicle starts cruising, and the potentials of the parts satisfy a relation of Vc≈Vb≈Vd.

When time point t3 comes, the power supply device according to Embodiment 2 performs the same operation as in the period from time point t2 to time point t3. As a result, the power to inverter 2 is supplied from first power storage device 1. The above corresponds to a period up to time point t4, at which the vehicle starts decelerating, and the potentials of the parts satisfy a relation of Vc≈Vb≈Vd.

When time point t4 comes, motor 3 regenerates power, and Vd rises. As a result, the conduction state of switch 6 is changed from the conducting state to the interrupted state. This prevents excessive regenerative current from flowing to first power storage device 1, preventing fast charge of first power storage device 1. The power regenerated by motor 3 is stored in second power storage device 5 via power converter 4A. At this time, the regenerative current may flow through high-side switch 47 being in the ON state or may flow through a body diode of high-side switch 47 being in the OFF state. The above corresponds to a period up to time point t5, at which control circuit 10A controls power converter 4A to cause power converter 4A to start operating as a converter (boost converter) that transfers the regenerated power from inverter 2 to second power storage device 5, and the potentials of the parts satisfy a relation of Vd Vc>Vb.

When time point t5 comes, control circuit 10A controls power converter 4A to cause power converter 4A to operate as a converter (boost converter) that transfers the regenerated power from inverter 2 to second power storage device 5. The power regenerated by motor 3 is thus stored in second power storage device 5. The above corresponds to a period up to time point t6, at which Vd reaches a predetermined threshold value, and the potentials of the parts satisfy a relation of Vc>Vd>Vb, a relation of Vc>Vb≈Vd, and a relation of Vc>Vb>Vd in this order with time. Note that, when Vb≈Vd, the conduction state of switch 6 is temporarily the conducting state, which is however not illustrated in FIG. 8. During a period in which the conduction state of switch 6 is temporarily the conducting state, the power regenerated by motor 3 is also stored in first power storage device 1.

When time point t6 comes, and Vd reaches the predetermined threshold value, control circuit 10A stops power converter 4A. This ends the storage of the power regenerated by motor 3 in second power storage device 5. At the same time, the vehicle further decelerates by a mechanical brake and then stops at time point t7.

As described above, in the power supply device according to Embodiment 2, the power regenerated by motor 3 is stored in second power storage device 5 even when Vd is in the range lower than Vc, by causing power converter 4A to operate as a converter that bucks voltage from the one terminal of second power storage device 5 to the power supply terminal of inverter 2 being the load, and boosts voltage from the power supply terminal of inverter 2 being the load to the one terminal of second power storage device 5, more specifically, by making power converter 4A have a configuration including the series circuit in which high-side switch 47 and low-side switch 48 are connected in series and that is disposed in parallel with second power storage device 5, and inductor 46 that is disposed between connection point LX between high-side switch 47 and low-side switch 48, and the power supply terminal of inverter 2 being the load, in the case where Vc is maintained at not less than Vd all the time.

### Embodiment 3

A power supply device according to Embodiment 3, which is configured such that power supply device 30 according to Embodiment 1 is partly altered, will be described below.

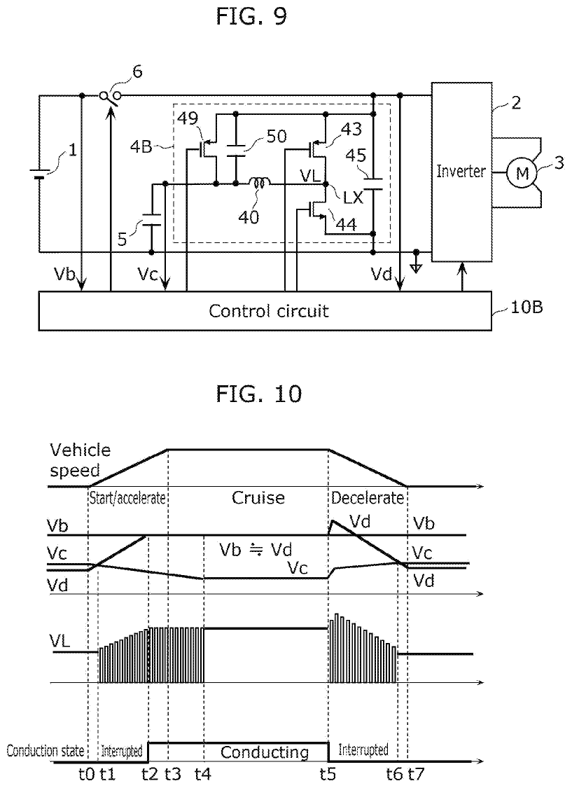

FIG. 9 is a block diagram of an example of a circuit configuration of a power supply device according to Embodiment 3. In the following description, constituent components of the power supply device according to Embodiment 3 that are the same as those of power supply device 30 according to Embodiment 1 will be denoted by the same reference characters and will not be described in detail because the constituent components have already been described. Differences from power supply device 30 will be mainly described.

As illustrated in FIG. 9, the power supply device according to Embodiment 3 is configured such that, from power supply device 30 according to Embodiment 1, power converter 4 is changed to power converter 4B and control circuit 10 is changed to control circuit 10B. In the power supply device according to Embodiment 3, Vc is maintained at equal to or less than Vd.

Control circuit 10B controls a conduction state of switch 6 as with control circuit 10 according to Embodiment 1. Control circuit 10B also controls operation of power converter 4B and operation of inverter 2. More specifically, control circuit 10B receives Vb, Vc, and Vd, and outputs a control signal for switch 6, a control signal for power converter 4B, and a control signal for inverter 2.

Power converter 4B is a converter that boosts voltage from one terminal of second power storage device 5 to a power supply terminal of inverter 2 being a load, and bucks voltage from the power supply terminal of inverter 2 being the load to the one terminal of second power storage device 5.

As illustrated in FIG. 9, power converter 4B includes second high-side switch 43, second low-side switch 44, inductor 40, smoothing capacitor 45, switch 49, and third power storage device 50.

Switch 49 is a PMOSFET and is disposed between the one terminal of second power storage device 5 and the power supply terminal of inverter 2 being the load.

Third power storage device 50 is disposed in parallel with switch 49. That is, third power storage device 50 includes one terminal connected to the one terminal of second power storage device 5 and the other terminal connected to the power supply terminal of inverter 2 being the load. Third power storage device 50 has a capacitance smaller than that of second power storage device 5.

Second high-side switch 43 and second low-side switch 44 are connected in series, forming a second series circuit. Hereinafter, in the second series circuit, a connection point between second high-side switch 43 and second low-side switch 44 will be denoted as LX, and a potential of connection point LX will be denoted as VL.

Inductor 40 includes one terminal connected to the one terminal of second power storage device 5 and the other terminal connected to connection point LX.

FIG. 10 is a timing chart illustrating how a vehicle speed of a vehicle, Vb, Vd, Vc, and VL, and the conduction state of switch 6 change with time. Here, description will be given on the assumption that a capacity of first power storage device 1 is sufficiently large, and variations in Vb with charging and discharging first power storage device 1 are negligibly small.

Before time point t0, the vehicle is in a stop state. At this time, power converter 4B and inverter 2 are stopped, and the conduction state of switch 6 is an interrupted state. It is assumed here that, before time point t0, Vb>Vc≈Vd holds.

During a period between time points t0 to t3, the vehicle starts/accelerates. When time point t0 comes, control circuit 10A causes inverter 2 to operate. This causes motor 3 to rotate, increasing the vehicle speed. At this time, power is supplied from second power storage device 5 to inverter 2 via a body diode of switch 49, and Vc decreases. The above corresponds to a period up to time point t1, at which Vc decreases to turn off the body diode of switch 49, and potentials of parts satisfy a relation of Vb>Vc≈Vd.

When time point t1 comes, the body diode of switch 49 is turned off, and control circuit 10B controls power converter 4B to cause power converter 4B to operate as a converter (boost converter) that supplies power from second power storage device 5 to inverter 2. As a result, Vc decreases. In a boost operation by power converter 4B, when second low-side switch 44 is on (when second high-side switch 43 is off), current flows in a path: second power storage device 5→inductor 40→second low-side switch 44→second power storage device 5, storing magnetic energy in inductor 40. When second low-side switch 44 is off (when second high-side switch 43 is on), current flows in a path: second power storage device 5→inductor 40→second high-side switch 43→smoothing capacitor 45→second power storage device 5, releasing the magnetic energy stored in inductor 40 to smoothing capacitor 45. As a result, smoothing capacitor 45 is charged, and Vd rises. The above corresponds to a period up to time point t2, at which Vd reaches Vb, and the potentials of the parts satisfy a relation of Vb>Vd>Vc.

When time point t2 comes, the conduction state of switch 6 is changed from the interrupted state to a conducting state, and power is supplied to inverter 2 also from first power storage device 1. As a result, the power to inverter 2 is supplied mainly from first power storage device 1. At the same time, the power supply from second power storage device 5 to inverter 2 also continues. Vc therefore continues decreasing. The above corresponds to a period up to time point t3, at which the vehicle starts cruising, and the potentials of the parts satisfy a relation of Vb≈Vd>Vc.

When time point t3 comes, the power supply device according to Embodiment 3 performs the same operation as in the period from time point t2 to time point t3. As a result, the power to inverter 2 is supplied mainly from first power storage device 1. At the same time, the power supply from second power storage device 5 to inverter 2 also continues. Vc therefore continues decreasing. The above corresponds to a period up to time point t4, at which Vc decreases to a predetermined amount, and the potentials of the parts satisfy a relation of Vb≈Vd>Vc. Here, this predetermined amount may be set at, for example, a minimum operating voltage of power converter 4B.

When time point t4 comes, control circuit 10B controls power converter 4B to stop the operation of power converter 4B. As a result, the power to inverter 2 is supplied from first power storage device 1. The above corresponds to a period up to time point t5, at which the vehicle starts decelerating, and the potentials of the parts satisfy a relation of Vb≈Vd>Vc.

When time point t5 comes, motor 3 regenerates power, and Vd rises. As a result, the conduction state of switch 6 is changed from the conducting state to the interrupted state. This prevents excessive regenerative current from flowing to first power storage device 1, preventing fast charge of first power storage device 1. At this time, the regenerative current flows to a series capacitance of third power storage device 50 and second power storage device 5. As a result, Vc rises. At the same time, control circuit 10B controls power converter 4B to cause power converter 4B to operate as a converter (buck converter) that transfers the regenerated power from inverter 2 to second power storage device 5. In a buck operation by power converter 4B, when second high-side switch 43 is on (when second low-side switch 44 is off), current flows in a path: smoothing capacitor 45→second high-side switch 43→inductor 40→second power storage device 5→smoothing capacitor 45, and current flows in a path: third power storage device 50→second high-side switch 43→inductor 40→third power storage device 50, discharging third power storage device 50, which suppresses an increase in a potential of third power storage device 50 by the regenerative current and rather decreases the potential. To decrease the potential of third power storage device 50, power stored in third power storage device 50 may be discharged by switch 49. Then, when second high-side switch 43 is off (when second low-side switch 44 is on), current flows in a path: inductor 40→second power storage device 5→second low-side switch 44→inductor 40, releasing the magnetic energy in inductor 40 to second power storage device 5. That is, power converter 4B stores the power regenerated by motor 3 in second power storage device 5 and, at the same time, discharges third power storage device 50. The above corresponds to a period up to time point t6, at which Vd reaches Vc, and the potentials of the parts satisfy a relation of Vd>Vb>Vc, a relation of Vd≈Vb>Vc, and a relation of Vb>Vd>Vc in this order with time. Note that, when Vb≈Vd, the conduction state of switch 6 is temporarily the conducting state, which is however not illustrated in FIG. 10. During a period in which the conduction state of switch 6 is temporarily the conducting state, the power regenerated by motor 3 is also stored in first power storage device 1.

When time point t6 comes, and Vd reaches Vc, control circuit 10B controls power converter 4B to stop the operation of power converter 4B. This ends the storage of the power regenerated by motor 3 in second power storage device 5. At the same time, the vehicle further decelerates by a mechanical brake and then stops at time point t7.

As described above, in the power supply device according to Embodiment 3, the power regenerated by motor 3 is stored in second power storage device 5 even when Vd is in the range lower than Vc, by causing power converter 4B to operate as a converter that boosts voltage from the one terminal of second power storage device 5 to the power supply terminal of inverter 2 being the load, and bucks voltage from the power supply terminal of inverter 2 being the load to the one terminal of second power storage device 5, more specifically, by making power converter 4B have a configuration including the series circuit in which second high-side switch 43 and second low-side switch 44 are connected in series and that is disposed in parallel with inverter 2 being the load, and inductor 40 that is disposed between connection point LX between second high-side switch 43 and second low-side switch 44, and the one terminal of second power storage device 5, in the case where Vc is maintained at equal to or less than Vd.

Additionally, since the other terminal of first power storage device 1 and the other terminal of second power storage device 5 are connected to the ground, the power supply device according to Embodiment 3 may be configured to use the third power storage device, one terminal of which is connected to the one terminal of second power storage device 5 and the other terminal is connected to the power supply terminal of inverter 2 being the load, to supply the power supply voltage to the power supply terminal of inverter 2 being the load. Third power storage device 50 may have a capacitance smaller than that of second power storage device 5 and can be used for voltage adjustment since power can be delivered between third power storage device 50 and second power storage device 5 by switching operation on second high-side switch 43 and second low-side switch 44.

Alternatively, power converter 4B may include switch 49 that is a discharging circuit for discharging third power storage device 50. With this configuration, when the power regenerated by motor 3 is stored in second power storage device 5, third power storage device 50 is actively discharged, enabling the power regenerated by motor 3 to be stored in second power storage device 5 more quickly.

### Embodiment 4

A power supply device according to Embodiment 4, which is configured such that the power supply device according to Embodiment 3 is partly altered, will be described below.

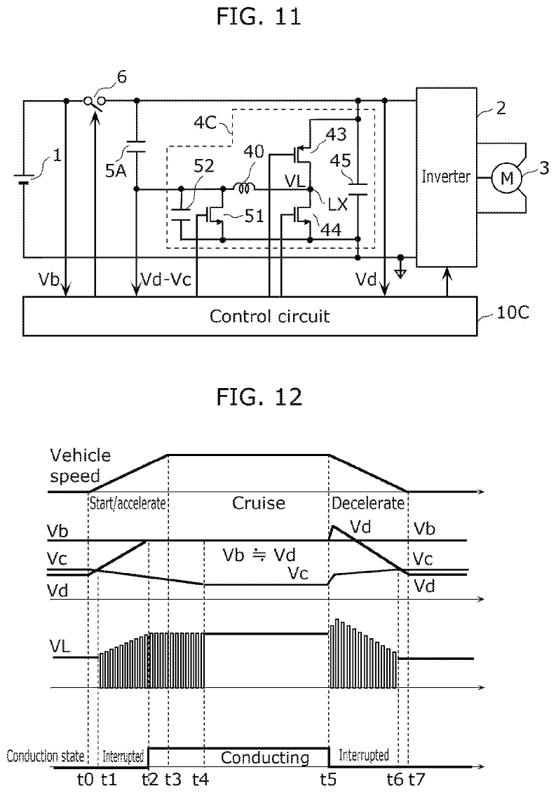

FIG. 11 is a block diagram of an example of a circuit configuration of a power supply device according to Embodiment 4. In the following description, constituent components of the power supply device according to Embodiment 4 that are the same as those of the power supply device according to Embodiment 3 will be denoted by the same reference characters and will not be described in detail because the constituent components have already been described. Differences from the power supply device according to Embodiment 3 will be mainly described.

As illustrated in FIG. 11, the power supply device according to Embodiment 4 is configured such that, from the power supply device according to Embodiment 3, second power storage device 5 is changed to second power storage device 5A, power converter 4B is changed to power converter 4C, and control circuit 10B is changed to control circuit 10C. In the power supply device according to Embodiment 4, Vc is maintained at equal to or less than Vd.

Second power storage device 5A includes one terminal and the other terminal and stores power between the one terminal and the other terminal. Second power storage device 5A is, for example, a capacitor, a secondary battery, or the like. In second power storage device 5A, the one terminal is connected to the power supply terminal of inverter 2 being a load, and the other terminal is connected to one terminal of third power storage device 52 to be described. Hereinafter, a potential of the one terminal of second power storage device 5A with respect to a potential of the other terminal will be denoted as Vc.

Control circuit 10C controls a conduction state of switch 6 as with control circuit 10B according to Embodiment 3. Control circuit 10C also controls operation of power converter 4C and operation of inverter 2. More specifically, control circuit 10C receives Vb, Vd−Vc, and Vd, and outputs a control signal for switch 6, a control signal for power converter 4B, and a control signal for inverter 2.

Power converter 4C is a converter that boosts voltage from the other terminal of second power storage device 5A to the power supply terminal of inverter 2 being the load, and bucks voltage from the power supply terminal of inverter 2 being the load to the other terminal of second power storage device 5A.

As illustrated in FIG. 11, power converter 4C includes second high-side switch 43, second low-side switch 44, inductor 40, smoothing capacitor 45, switch 51, and third power storage device 52.

Switch 51 is an NMOSFET and is disposed between the other terminal of second power storage device 5A and the ground.

Third power storage device 52 is disposed in parallel with switch 51. That is, third power storage device 52 includes the one terminal connected to the other terminal of second power storage device 5A and the other terminal connected to the ground. Third power storage device 52 has a capacitance smaller than that of second power storage device 5A.

Inductor 40 includes one terminal connected to the other terminal of second power storage device 5A and the other terminal connected to connection point LX.

FIG. 12 is a timing chart illustrating how a vehicle speed of a vehicle, Vb, Vd, Vc, and VL, and the conduction state of switch 6 change with time. Here, description will be given on the assumption that a capacity of first power storage device 1 is sufficiently large, and variations in Vb with charging and discharging first power storage device 1 are negligibly small.

Before time point t0, the vehicle is in a stop state. At this time, power converter 4B and inverter 2 are stopped, and the conduction state of switch 6 is an interrupted state. It is assumed here that, before time point t0, Vb>Vc≈Vd holds.

During a period between time points t0 to t3, the vehicle starts/accelerates. When time point t0 comes, control circuit 10A causes inverter 2 to operate. This causes motor 3 to rotate, increasing the vehicle speed. At this time, power is supplied from second power storage device 5A to inverter 2 via a body diode of switch 51, and Vc decreases. The above corresponds to a period up to time point t1, at which Vc decreases to turn off the body diode of switch 51, and potentials of parts satisfy a relation of Vb>Vc≈Vd.

When time point t1 comes, the body diode of switch 51 is turned off, and control circuit 10C controls power converter 4C to cause power converter 4C to operate as a converter (inverting converter) that supplies power from second power storage device 5A to third power storage device 52. In an inverting operation by power converter 4C, when second high-side switch 43 is on (when second low-side switch 44 is off), current flows in a path: second power storage device 5A→second high-side switch 43→inductor 40→second power storage device 5A, storing magnetic energy in inductor 40. Then, when second high-side switch 43 is off (when second low-side switch 44 is on), current flows in a path: inductor 40→third power storage device 52→second low-side switch 44→inductor 40, releasing the magnetic energy stored in inductor 40 to third power storage device 52. Third power storage device 52 is thereby charged, increasing a potential (Vd−Vc) of the one terminal of third power storage device 52.

That is, while power is supplied to inverter 2 from a series capacitance of second power storage device 5A and third power storage device 52, power is supplied to third power storage device 52 from second power storage device 5A. Thus, an increase in the potential (Vd−Vc) of third power storage device 52 compensates for the decrease in Vc, increasing a potential Vd. The above corresponds to a period up to time point t2, at which Vd reaches Vb, and the potentials of the parts satisfy a relation of Vb>Vd>Vc.

When time point t2 comes, the conduction state of switch 6 is changed from the interrupted state to a conducting state, and power is supplied to inverter 2 also from first power storage device 1. As a result, the power to inverter 2 is supplied mainly from first power storage device 1. At the same time, the power supply from the series capacitance of second power storage device 5A and third power storage device 52 to inverter 2 also continues. Vc therefore continues decreasing. The above corresponds to a period up to time point t3, at which the vehicle starts cruising, and the potentials of the parts satisfy a relation of Vb≈Vd>Vc.

When time point t3 comes, the power supply device according to Embodiment 4 performs the same operation as in the period from time point t2 to time point t3. As a result, the power to inverter 2 is supplied mainly from first power storage device 1. At the same time, the power supply from the series capacitance of second power storage device 5A and third power storage device 52 to inverter 2 also continues. Vc therefore continues decreasing. The above corresponds to a period up to time point t4, at which Vc decreases to a predetermined amount, and the potentials of the parts satisfy a relation of Vb≈Vd>Vc. Here, this predetermined amount may be set at, for example, a minimum operating voltage of power converter 4B.

When time point t4 comes, control circuit 10C controls power converter 4C to stop the operation of power converter 4C. As a result, the power to inverter 2 is supplied from first power storage device 1. The above corresponds to a period up to time point t5, at which the vehicle starts decelerating, and the potentials of the parts satisfy a relation of Vb≈Vd>Vc.

When time point t5 comes, motor 3 regenerates power, and Vd rises. As a result, the conduction state of switch 6 is changed from the conducting state to the interrupted state. This prevents excessive regenerative current from flowing to first power storage device 1, preventing fast charge of first power storage device 1. At this time, the regenerative current flows to the series capacitance of second power storage device 5A and third power storage device 52. As a result, Vc rises. At the same time, control circuit 10C controls power converter 4C to cause power converter 4C to operate as a converter (inverting converter) that supplies power from third power storage device 52 to second power storage device 5A. In an inverting operation by power converter 4C, when second low-side switch 44 is on (when second high-side switch 43 is off), current flows in a path: third power storage device 52→inductor 40→second low-side switch 44→third power storage device 52, storing magnetic energy in inductor 40. Then, when second low-side switch 44 is off (when second high-side switch 43 is on), current flows in a path: inductor 40→second high-side switch 43→second power storage device 5A→inductor 40, storing power in second power storage device 5A. This suppresses an increase in the potential of third power storage device 52 by the regenerative current and rather decreases the potential. To decrease the potential of third power storage device 52, power stored in third power storage device 52 may be discharged by switch 51. That is, power converter 4C stores the power regenerated by motor 3 in second power storage device 5A and, at the same time, discharges third power storage device 52. The above corresponds to a period up to time point t6, at which Vd reaches Vc, and the potentials of the parts satisfy a relation of Vd>Vb>Vc, a relation of Vd Vb>Vc, and a relation of Vb>Vd>Vc in this order with time. Note that, when Vb≈Vd, the conduction state of switch 6 is temporarily the conducting state, which is however not illustrated in FIG. 12. During a period in which the conduction state of switch 6 is temporarily the conducting state, the power regenerated by motor 3 is also stored in first power storage device 1.

When time point t6 comes, and Vd reaches Vc, control circuit 10C controls power converter 4C to stop the operation of power converter 4C. This ends the storage of the power regenerated by motor 3 in second power storage device 5A. At the same time, the vehicle further decelerates by a mechanical brake and then stops at time point t7.

As described above, in the power supply device according to Embodiment 4, the power regenerated by motor 3 is stored in second power storage device 5A even when Vd is in the range lower than Vc, by causing power converter 4C to operate as a converter that boosts voltage from the other terminal of second power storage device 5A to the power supply terminal of inverter 2 being the load, and bucks voltage from the power supply terminal of inverter 2 being the load to the other terminal of second power storage device 5A, more specifically, by making power converter 4C have a configuration including the series circuit in which second high-side switch 43 and second low-side switch 44 are connected in series and that is disposed in parallel with inverter 2 being the load, and inductor 40 that is disposed between connection point LX between second high-side switch 43 and second low-side switch 44, and the other terminal of second power storage device 5A, in the case where Vc is maintained at equal to or less than Vd.

Additionally, since the other terminal of first power storage device 1 is connected to the ground, and the one terminal of second power storage device 5A is connected to the power supply terminal of inverter 2 being the load, the power supply device according to Embodiment 4 may be configured to use third power storage device 52, the one terminal of which is connected to the one terminal of second power storage device 5A and the other terminal is connected to the ground, to supply the power supply voltage to the power supply terminal of inverter 2 being the load. Third power storage device 52 may have a capacitance smaller than that of second power storage device 5A and can be used for voltage adjustment since power can be delivered between third power storage device 52 and second power storage device 5A by switching operation on second high-side switch 43 and second low-side switch 44.

Alternatively, power converter 4C may include switch 51 that is a discharging circuit for discharging third power storage device 52. With this configuration, when the power regenerated by motor 3 is stored in second power storage device 5A, third power storage device 52 is actively discharged, enabling the power regenerated by motor 3 to be stored in second power storage device 5A more quickly.

### Other Embodiments

In Embodiment 1 to Embodiment 4, switch 6 is described as a bi-directional switch implemented in a form of a semiconductor circuit, as illustrated in FIG. 4. Switch 6 is, however, not necessarily limited to a bi-directional switch implemented in a form of a semiconductor circuit. For example, switch 6 may be a mechanical switch such as a relay. Note that switch 6 is desirably an active element capable of controlling conducting current because switch 6 is for preventing excessive charge-discharge current to first power storage device 1 so as to prolong a life of first power storage device 1.

The power supply device according to Embodiment 3 or the power supply device according to Embodiment 4 may be provided with a capacitor connected in series to second power storage device 5 or second power storage device 5A and having a capacitance smaller than that of second power storage device 5 or second power storage device 5A, and may be configured to control the potentials properly by delivering electrical charge between second power storage device 5 or second power storage device 5A and the capacitor.

As described above, the power supply device according to any one of Embodiment 1 to Embodiment 4 can reduce the power loss in the power transfer between first power storage device 101 and the load. Furthermore, in the power supply device according to any one of Embodiment 1 to Embodiment 4, the power regenerated by motor 3 can be stored in second power storage device 5 or second power storage device 5A even when Vd is in the range lower than Vb. As such, it is particularly effective to apply the power supply device according to any one of Embodiment 1 to Embodiment 4 to an electric vehicle and a hybrid vehicle in which a voltage of its battery becomes at least 30 V, a relatively high voltage.

Although a power supply device according to an aspect of the present disclosure has been described above based on Embodiments 1 to 4, the present disclosure is not limited to these embodiments. One or more aspect of the present disclosure may include forms obtained by making various modifications to these embodiments that can be conceived by those skilled in the art, as well as forms obtained by combining structural components in different embodiments, without departing from the essence of the present disclosure.

### INDUSTRIAL APPLICABILITY

The present disclosure is widely useful in a power supply device.

1. A power supply control device that supplies a power supply voltage to a power supply terminal of a load, using a first power storage device and a second power storage device as power sources, the power supply control device comprising:
a power converter;
a switch disposed between one terminal of the first power storage device and the power supply terminal of the load; and
a control circuit that controls a conduction state of the switch.

2. The power supply control device according to claim 1, wherein
the power converter is disposed between one terminal of the second power storage device and the power supply terminal of the load.

3. The power supply control device according to claim 2, wherein
the control circuit places the switch in a conducting state when a potential difference between the one terminal of the first power storage device and the power supply terminal of the load is smaller than a predetermined amount.

4. The power supply control device according to claim 2, wherein
the power converter is a buck-boost converter capable of bi-directional power transfer.

5. The power supply control device according to claim 4, wherein
the buck-boost converter includes:
a first series circuit in which a first high-side switch and a first low-side switch are connected in series, and which is disposed in parallel with the second power storage device;
a second series circuit in which a second high-side switch and a second low-side switch are connected in series, and which is disposed in parallel with the load; and
an inductor disposed between (i) a connection point of the first high-side switch and the first low-side switch and (ii) a connection point of the second high-side switch and the second low-side switch.

6. The power supply control device according to claim 2, wherein
the power converter is a converter that bucks voltage from the one terminal of the second power storage device to the power supply terminal of the load, and boosts voltage from the power supply terminal of the load to the one terminal of the second power storage device.

7. The power supply control device according to claim 6, wherein
the converter includes:
a series circuit in which a high-side switch and a low-side switch are connected in series, and which is disposed in parallel with the second power storage device; and
an inductor disposed between (i) a connection point of the high-side switch and the low-side switch and (ii) the power supply terminal of the load.

8. The power supply control device according to claim 2, wherein
the power converter is a converter that boosts voltage from the one terminal of the second power storage device to the power supply terminal of the load, and bucks voltage from the power supply terminal of the load to the one terminal of the second power storage device.

9. The power supply control device according to claim 8, wherein
the converter includes:
a series circuit in which a high-side switch and a low-side switch are connected in series, and which is disposed in parallel with the load; and
an inductor disposed between (i) a connection point of the high-side switch and the low-side switch and (ii) the one terminal of the second power storage device.

10. The power supply control device according to claim 1, wherein
the power converter is a converter that boosts voltage from an other terminal of the second power storage device to the power supply terminal of the load, and bucks voltage from the power supply terminal of the load to the other terminal of the second power storage device.

11. The power supply control device according to claim 10, wherein
the converter includes:
a series circuit in which a high-side switch and a low-side switch are connected in series, and which is disposed in parallel with the load; and
an inductor disposed between (i) a connection point of the high-side switch and the low-side switch and (ii) the other terminal of the second power storage device.

12. The power supply control device according to claim 1, wherein
the first power storage device has a voltage of at least 30 V.

13. A power supply device which comprises a first power storage device and a second power storage device, and supplies power supply voltage to a power supply terminal of a load, using the first power storage device and the second power storage device as power sources, wherein
the power supply device further comprises:
a power converter;
a switch disposed between one terminal of the first power storage device and the power supply terminal of the load; and
a control circuit that controls a conduction state of the switch.

14. The power supply device according to claim 13, wherein
the power converter is disposed between one terminal of the second power storage device and the power supply terminal of the load.

15. The power supply device according to claim 13, wherein
the power converter is a converter that boosts voltage from an other terminal of the second power storage device to the power supply terminal of the load, and bucks voltage from the power supply terminal of the load to the other terminal of the second power storage device.
